(19) United States
(12) Patent Application Publication
(10) Pub. No.: US 2025/0269783 A1
(43) Pub. Date: Aug. 28, 2025

(54) RECREATIONAL VEHICLE WITH ADJUSTABLE SLEEPING UNIT AND SYSTEM THEREOF

(71) Applicant: Forest River, Inc., Elkhart, IN (US)

(72) Inventors: Todd Wayne Grubb, Niles, MI (US); Kevin S. Woolwine, Elkhart, IN (US)

(21) Appl. No.: 19/062,104

(22) Filed: Feb. 25, 2025

Related U.S. Application Data
(60) Provisional application No. 63/558,220, filed on Feb. 27, 2024.

(51) Int. Cl. B60P 3/36; B60N 3/00

(52) U.S. Cl. CPC B60P 3/36; B60N 3/008

(57) ABSTRACT

A vehicle with an interior defined by a floor, ceiling, and a plurality of walls. The vehicle including a first and second sleeping unit positioned in the interior, the first and second sleeping units each configured to move between a deployed position and a stowed position. The vehicle including a first lower supporting member coupled to one or more of the plurality of walls, the first lower supporting member configured to support the second sleeping unit in the deployed position. When the first sleeping unit moves from the deployed position to the stowed position, the first sleeping unit moves towards the ceiling and when the second sleeping unit moves from the deployed position to the stowed position, the second sleeping unit is folded against one of the plurality of walls.

### CROSS-REFERENCE TO RELATED APPLICATION

This application claims the benefit of and priority to U.S. Provisional Patent Application No. 63/558,220, filed Feb. 27, 2024, the disclosure of which is hereby incorporated herein by reference in its entirety.

### FIELD OF THE DISCLOSURE

The present disclosure relates to a recreational vehicle such as a travel trailer or fifth wheel travel trailer, and more particularly to a recreational vehicle with an adjustable sleeping unit.

### BACKGROUND

Recreational vehicles provide individuals with comfortable and transportable lodging. However, motorhomes generally have limited space to provide accommodations, and providing beds in such vehicles presents a problem of using space that could be used for other accommodations. Recreational vehicles have utilized lofted beds in the past, where a bed is mounted towards a ceiling of the recreational vehicle and accommodations may be arranged under the bed. Generally, these lofted beds reduce the usable height of the space under the lofted beds, which also limits accommodations that may be arranged thereunder.

### SUMMMARY

In one implementation of the present disclosure, a vehicle includes an interior defined by a floor, ceiling, and a plurality of walls. The vehicle also includes a first and second sleeping unit positioned in the interior, the first and second sleeping units each configured to move between a deployed position and a stowed position. The vehicle can include a first lower supporting member coupled to one or more of the plurality of walls, the first lower supporting member configured to support the second sleeping unit in the deployed position. When the first sleeping unit moves from the deployed position to the stowed position, the first sleeping unit moves towards the ceiling and when the second sleeping unit moves from the deployed position to the stowed position, the second sleeping unit is folded against one of the plurality of walls.

In one example of this implementation, the vehicle can include a second lower supporting member coupled to one of the plurality of walls opposite the first lower supporting member. In a second example, one of the first or second lower supporting members comprises a work surface. In a third example of this implementation, the vehicle can include first and second upper supporting members configured to support the first sleeping unit, wherein the upper supporting members include one or more dampers configured to move between an extended position and a compressed position. In a fourth example, the vehicle can include a lock, wherein at least one of the first and second sleeping units are configured to lock in the stowed position via the lock.

In another example of this implementation, the first sleeping unit is positioned over the second sleeping unit such that the first sleeping unit and the second sleeping unit occupy the same floor space when the first and second sleeping units are deployed. In a sixth example of this implementation, the first sleeping unit is positioned above the second sleeping unit. In a seventh example, the first unit moves between the deployed and stowed positions independently relative to the second sleeping unit, and the second sleeping unit moves between the deployed and stowed positions independently relative to the first sleeping unit. In an eighth example of this implementation, the first and second sleeping units each comprise a platform and a mattress.

In another implementation of the present disclosure, a reconfigurable compartment includes two opposed walls and a ceiling with a work surface positioned between the two opposed walls. The compartment also includes an upper sleeping unit configured to move between a deployed position and an elevated stowed position, and a lower sleeping unit is configured to move between a deployed position supported by the work surface and a stowed position.

In one example of this implementation, the upper sleeping unit is positioned against the ceiling in the stowed position. In a second example, the lower sleeping unit is folded in the stowed position. In a third example of this implementation, the compartment can include a supporting member coupled to one of the two opposed walls opposite the work surface and at the same height as the work surface. In a fourth example of this implementation, the compartment can include first and second upper supporting members configured to support the upper sleeping unit, wherein the upper supporting members include one or more dampers configured to move between an extended position and a compressed position when the upper sleeping unit is moved from the stowed position to the deployed position. In a fifth example, the compartment can include a lock, wherein at least one of the upper and lower sleeping units are configured to lock in the stowed position via the lock.

In another example of this implementation, the upper sleeping unit is positioned over the lower sleeping unit such that the upper sleeping unit and the lower sleeping unit occupy the same floor space when the upper and lower sleeping units are deployed. In a seventh example of this implementation, the upper sleeping unit moves between the deployed and stowed positions independently relative to the lower sleeping unit, and the lower sleeping unit moves between the deployed and stowed positions independently relative to the upper sleeping unit. In an eighth example of this implementation, the upper and lower sleeping units each comprise a platform and a mattress. In a nineth example, the work surface has an L-configuration, whereby a first portion of the work surface is positioned against one of the two opposed walls and a second portion of the work surface is positioned against a back wall extending between the two opposed walls. In a tenth example of this implementation, the lower sleeping unit is folded against the back wall in the stowed position.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a side view of one example implementation of a recreational vehicle;

FIG. 2 is a perspective view of an interior portion of an example implementation of a recreational vehicle with an upper and lower sleeping unit in deployed positions;

FIG. 3 is a perspective view of the interior portion of the recreational vehicle of FIG. 2, with the upper sleeping unit in the deployed position and the lower sleeping unit in a stowed position;

FIG. 4 is a zoomed-in perspective view of the interior portion of the recreational vehicle of FIG. 2, illustrating a first upper supporting member with the upper and lower sleeping units in stowed positions;

FIG. 5 is a zoomed-in perspective view of the interior portion of the recreational vehicle of FIG. 2, illustrating a second upper supporting member with the upper and lower sleeping units in stowed positions;

FIG. 6 is a perspective view of the interior portion of the recreational vehicle of FIG. 2, with the upper sleeping unit in the stowed position and the lower sleeping unit in the stowed position;

FIG. 7 is a rear side perspective view of another example implementation of a recreational vehicle; and

FIG. 8 is a schematic of one example implementation of a floor layout of a recreational vehicle.

Corresponding reference numerals are used to indicate corresponding parts throughout the several views.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

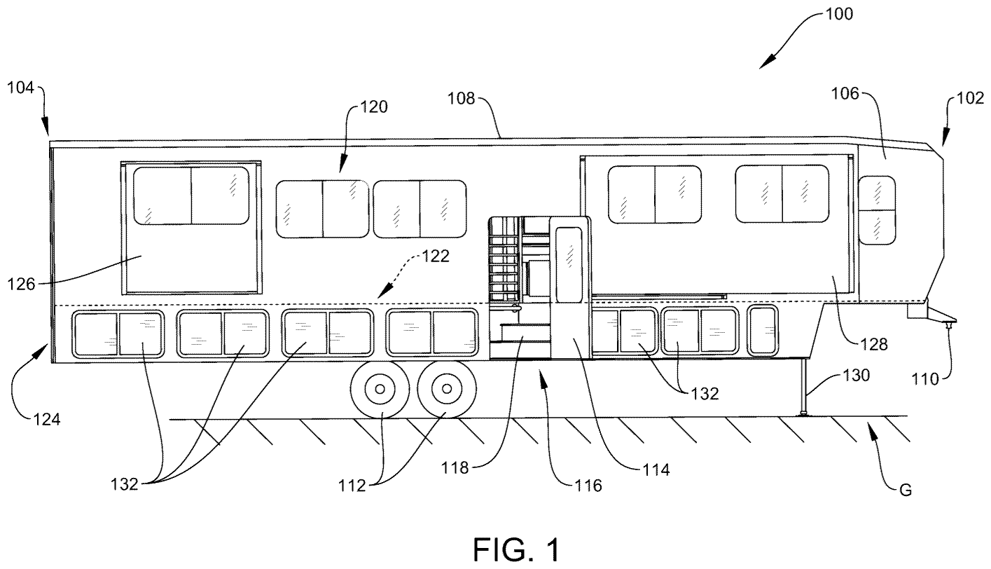

Referring to FIG. 1, an implementation of a recreational vehicle in the form of a recreational vehicle 100 is illustrated. While a fifth wheel is shown in FIG. 1, the present disclosure is not limited to fifth wheel travel trailers. Any type of travel trailer or recreational vehicle may be relevant to the present disclosure such as, for example, a motorhome, toy hauler, travel trailer, destination trailer, or tent camper. In any event, the recreational vehicle 100 may include a front end 102 and a rear end 104. For instance, an interior floor 122 of the recreational vehicle 100 may lie along a substantially horizontal plane between the front 102 and rear 104 thereof. The single-level recreational vehicle 100 may be formed as a body 106 supported by a frame assembly or chassis. The frame assembly or chassis may be a drop frame assembly or a straight frame assembly. The body 106 and frame assembly may be further supported by one or more wheels 112.

The body 106 may include an overhead roof 108 as shown in FIG. 1. Further, a hitch 110 may be located at the front end 102 of the trailer for coupling to a towing motorized or powered vehicle (not shown). When the recreational vehicle 100 is disconnected from the towing vehicle, a support member 130 or landing gear may be provided to support the front end 102 thereof. According to some examples, the body 106 may include skirting.

A door 114 may be coupled to the body 106 to allow access between the interior of the recreational vehicle 100 and outside thereof. The door 114, when opened, allows access to an entryway 116 which may be accessed by a set of steps 118 between the ground, G, and a living area 120 of the recreational vehicle 100. In one embodiment, the entryway 116 may have a width greater than the typical 30″ found on some multi-level fifth wheel trailers. For instance, the passageway 116 may have a width between 30-40 inches. In a further example, the width may be between 32-38 inches. In yet a further example, the width may be approximately 36 inches. The present disclosure is not intended to be limited to any type of width of the entryway 116.

The recreational vehicle 100 may include a first slide out 126 and a second slide out 128. The slide outs 126, 128, when configured in their deployed positions, may allow the living area 120 to increase in living space as the side wall of the body 106 may move outwardly a predetermined distance. While the recreational vehicle 100 of FIG. 1 includes a pair of slide outs 126, 128, this is not intended to be limiting. The recreational vehicle 100 may include any number of slide outs for purposes of the present disclosure, and in some examples, the recreational vehicle 100 may not include a slide out.

The travel trailer may include a height defined between the floor 122 and ceiling. In some embodiments, the height may be approximately the same throughout, whereas in other embodiments, the height may vary between the front 102 and rear 104. In FIG. 1, a one height, H₁, at the rear 104 of the recreational vehicle 100 may be approximately, if not exactly, the same as another height, H₂, at the front 102 thereof. For example, the heights may be up to 84 inches. Conventional multi-level fifth wheel travel trailers having varying heights throughout the interior living spaces depending upon the location therein. For instance, a conventional multi-level fifth wheel may have heights that vary between 75 inches and 105 inches, where the less headroom is normally found in those living spaces that are elevated at the front and/or rear of the trailer.

The floor level 122 may separate the living space 120 of the recreational vehicle 100 from a storage compartment or basement 124. The storage compartment 124 may be accessed by any one of a plurality of storage doors 132. The storage compartment 124 of the travel recreational vehicle 100 of FIG. 1 may be individual compartments or a full pass-through storage space that runs continuously (e.g., uninterrupted) from the rear end 104 of the recreational vehicle 100 to a location towards the front end 102 thereof. In FIG. 1, for example, the storage compartment 124 may be a continuous space defined between a point at the rear 104 and a point towards the front 102. The storage compartment 124 may be formed of a single piece of composite material which can reduce the overall cost of the recreational vehicle 100. In other embodiments, the storage compartment 124 may be formed of other material besides composite. According to some examples, the recreational vehicle 100 may not include a storage compartment or basement 124 thereunder.

In many conventional recreational vehicles, a roof assembly is sloped or angled to both sides of the vehicle to induce water, debris, and the like to flow off either side thereof. Many conventional recreational vehicles include gutters disposed adjacent to the roof assembly on both sides of the vehicle to collect water, debris, and the like. The gutters are oriented to move the water, debris, and the like towards the front or rear of the vehicle where the water, debris, and the like are discharged.

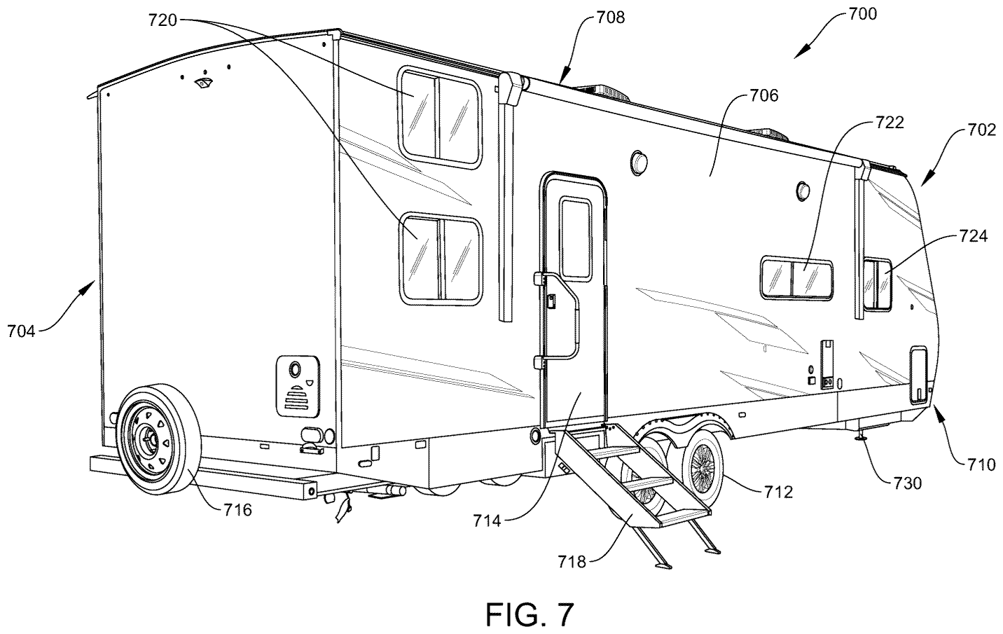

In FIG. 7 of the present disclosure, another example implementation of a recreational vehicle 700 is illustrated. In this example implementation, the recreational vehicle 700 is shown as a travel trailer. As described above, the present disclosure is not limited to any type of recreational vehicle and may include a travel trailer, a fifth wheel, a motorhome, etc. In FIG. 7, the recreational vehicle 700 includes a front portion or end 702 and a rear portion or end 704. The recreational vehicle 700 is formed as a body 706 having one or more walls that form an interior of the recreational vehicle. The body 706 is supported on a frame or chassis which in turn is movably supported an underlying surface by one or more wheels 712. A spare wheel 716 may also be provided. In FIG. 7, the spare wheel 716 may be coupled to the rear portion 704 of the body 706. The recreational vehicle 700 includes a roof structure 708.

The recreational vehicle 700 may include a hitch 710 for towing the recreational vehicle 700 by a towing vehicle. A support member 730 is shown supporting the recreational vehicle 700 when the recreational vehicle 700 is not attached to a towing vehicle.

The recreational vehicle 700 includes at least one door 714 for entering or exiting the interior of the recreational vehicle 700. One or more steps 718 may be provided for a user to access the door 714 from the outside of the recreational vehicle 700.

The recreational vehicle 700 may include a first set of windows 720 located towards the rear portion 704 of the recreational vehicle 700. A second window or windows 722 may be located generally towards a middle portion of the recreational vehicle 700, and a third window or windows 724 is located towards the front portion 702 thereof. Alternative arrangements of windows and doors may be provided in other implementations. Moreover, the recreational vehicle 700 of FIG. 7 is not shown including a slide-out but is it to be understood that in other implementations the recreational vehicle 700 may include one or more implementations.

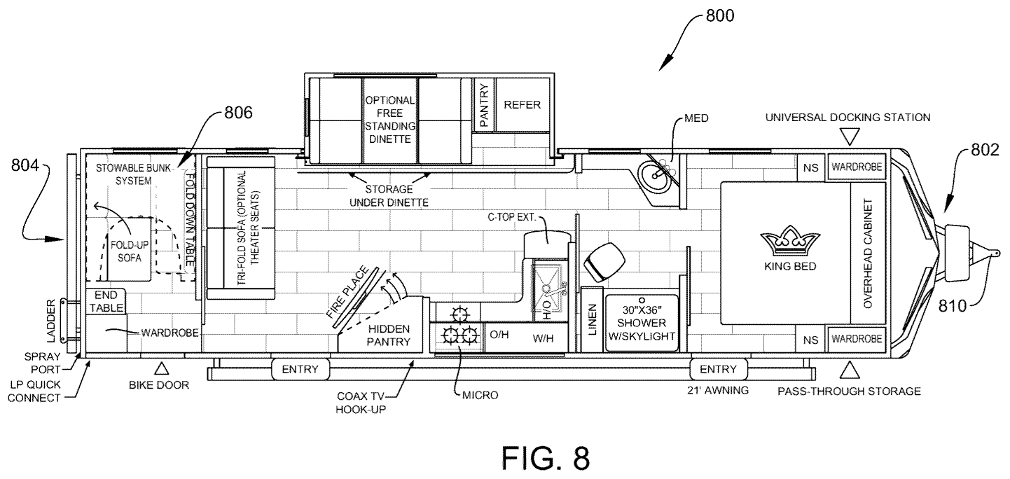

Turning to FIG. 8, one example implementation of a floor layout 800 of an interior of a recreational vehicle is shown. The recreational vehicle in FIG. 8 includes a front portion 802 and a rear portion 804. The recreational vehicle includes a hitch or hitch assembly 810 towards the front portion 802. In this implementation, a bedroom having a bed, shower, sink, and toilet are located towards the front portion 802 of the recreational vehicle. Further, a living space including a dinette (e.g., table and seating), fireplace, kitchen, utilities, and entertainment options (e.g., television, screen, etc.) may be located generally in a middle portion (i.e., between the front portion and rear portion) of the recreational vehicle. Moreover, an office and sleeping space is generally shown towards the rear portion 804 of the recreational vehicle. The office and sleeping space may be configurable between an office space configuration with a desk or table and a sleeping space configuration in which an upper and lower sleeping units are provided. Additional details about these different configurations and implementations thereof will now be described.

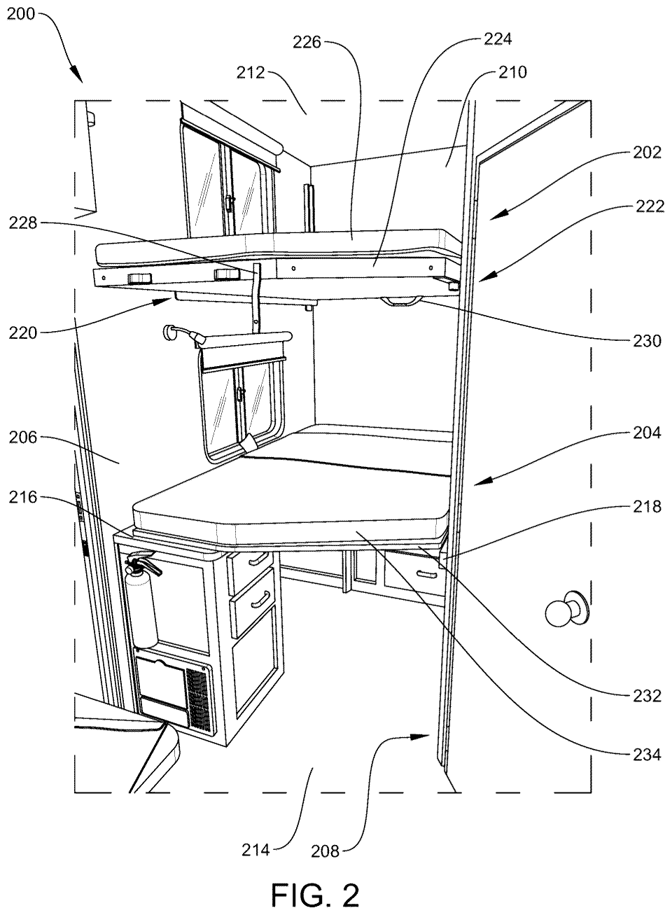

Referring to FIG. 2 of the present disclosure, one example of an interior portion 200 of a recreational vehicle 100, 700 is shown. As in the illustrative example of FIG. 2, the interior portion 200 may include an upper sleeping unit and a lower sleeping unit 204, and the upper and lower sleeping units 202, 204 may be in a deployed position. The first and second sleeping units 202, 204 may move between the deployed and a stowed position. In some examples, as illustrated in FIG. 2, both the upper and lower sleeping units 202, 204 may be in the deployed position. In other examples, one of the upper or lower sleeping units 202, 204 may be in the deployed position. According to some embodiments, both the upper and lower sleeping units 202, 204 may be in the stowed position.

The sleeping units 202, 204 may be positioned between a first sidewall 206, second sidewall 208, and a back wall 210, and may also be positioned between a ceiling 212 and a floor 214 of the interior portion 200 of the recreational vehicle 100, 700. When the lower sleeping unit 204 is in the deployed position, the lower sleeping unit 204 may be supported by first and second lower supporting members 216, 218. When the upper sleeping unit 202 is in the deployed position, the upper sleeping unit 202 may be supported by first and second upper supporting members 220, 222.

According to the example illustrated in FIG. 2, the upper sleeping unit 202 may include an upper frame 224 and an upper mattress 226. In some examples, the upper frame 224 and upper mattress 226 may be foldable. In other examples, the upper frame 224 and upper mattress 226 may not be foldable. The upper sleeping unit 202 may also include one or more handles. More specifically, a front handle 228 and back handle 230 may be coupled to the upper frame 224. In some examples, the handles 228, 230 may be coupled to the upper mattress 226, or to another portion of the upper sleeping unit 202. The handles 228, 230 may be configured to move the upper sleeping unit 202 between stowed and deployed positions. Other handle configurations in addition to a front handle 228 and a back handle 230 are also considered herein.

As illustrated in FIG. 2, the lower sleeping unit 204 may include a lower platform or frame 232 and a lower mattress 234. According to some examples, the lower frame 232 and lower mattress 234 may be foldable. In some examples, the lower frame 232 and lower mattress 234 may not be foldable. According to some examples, the lower sleeping unit 204 may include one or more handles. In some examples, the lower sleeping unit 204 may not include a handle.

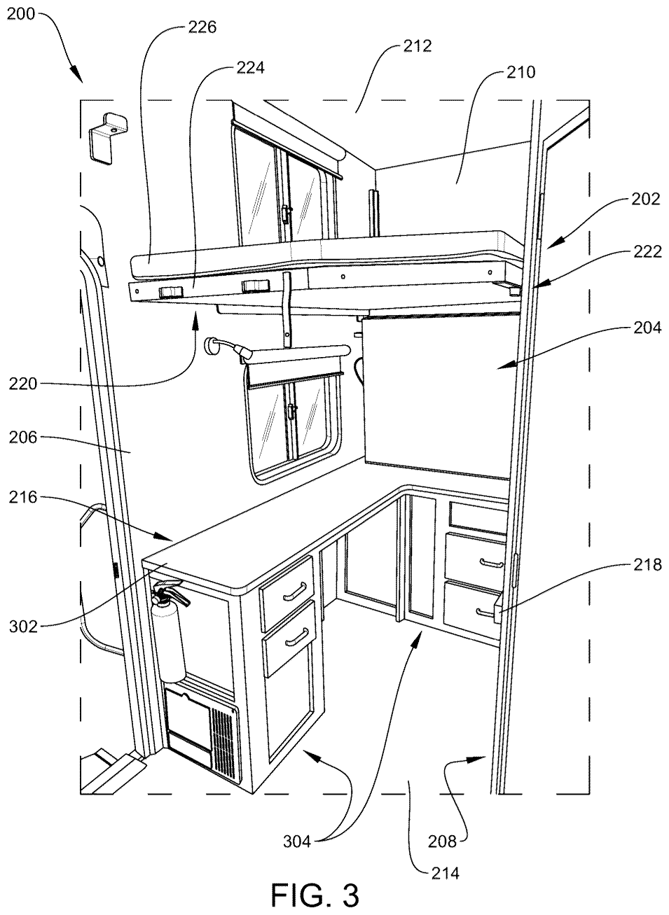

Referring now to FIG. 3, the interior portion 200 of the recreational vehicle 100, 700 is illustrated with the upper sleeping unit 202 in the deployed position and the lower sleeping unit 204 in the stowed position. In the illustrative examples of FIGS. 2-3, the lower frame 232 and lower mattress 234 may be foldable. When the lower sleeping unit 204 is in the stowed position, the lower frame 232 may be folded and may extend between the first and second lower supporting members 216, 218 and the first and second upper supporting members 220, 222. According to some examples, when the lower sleeping unit 202 is in the stowed position, the lower frame 232 may be folded and may be positioned vertically or aligned with the back wall 210.

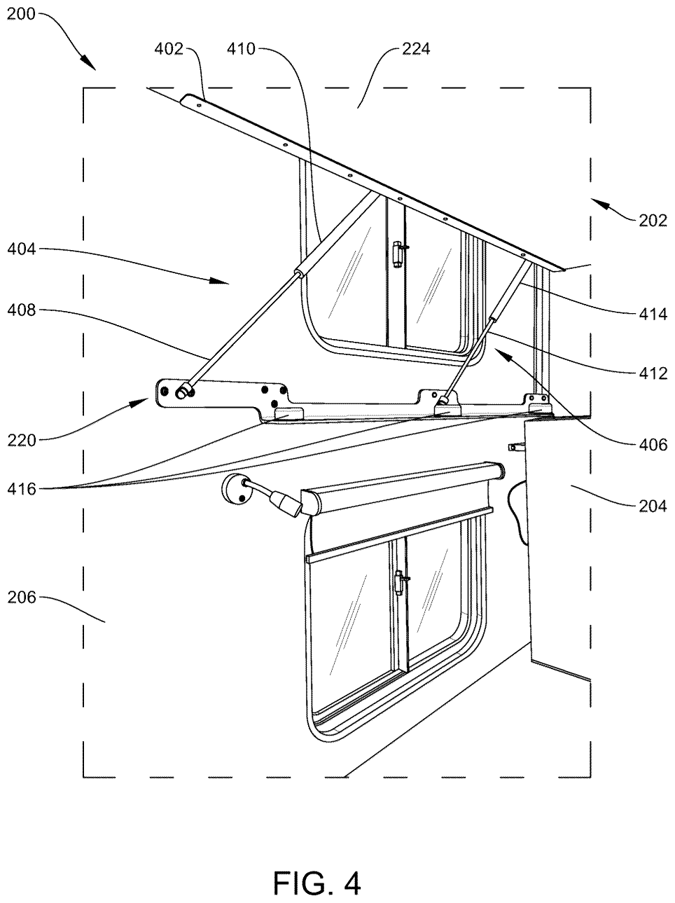

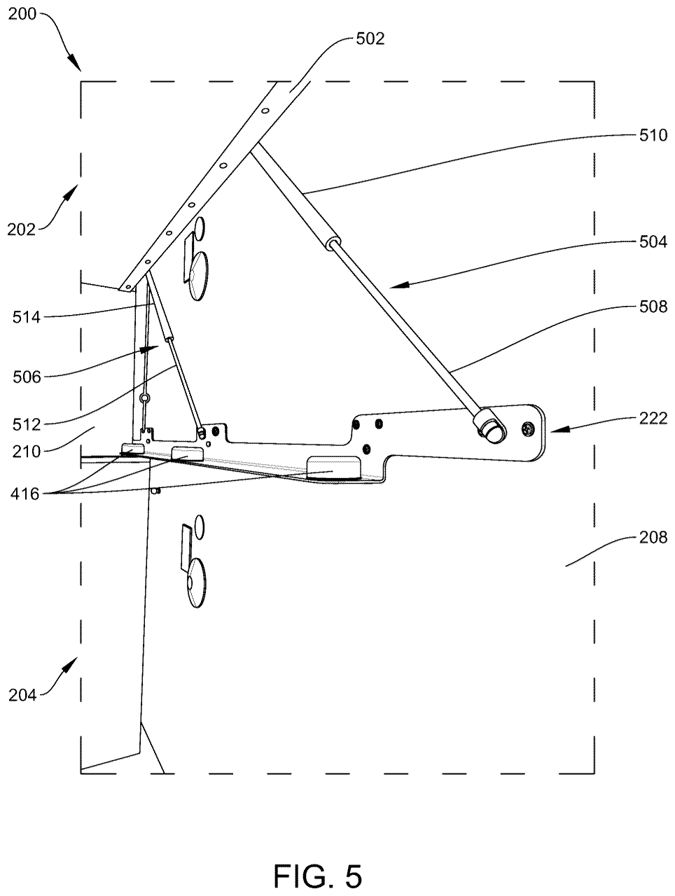

The lower sleeping unit 204 may lock or latch into the stowed position. More specifically, the lower sleeping unit may have a first lower locking mechanism 802 and a second lower locking mechanism 702 (see FIGS. 4 and 5).

As illustrated in FIG. 3, the first lower supporting member 216 may include a countertop 302 and one or more base cabinets 304. In some examples, the one or more base cabinets 304 may be supported by the floor 214, may include drawers or doors. In the illustrative example of FIG. 3, the countertop 302 may be supported by the one or more base cabinets 304. As in FIG. 3, the countertop may have an L-configuration, wherein a first portion of the countertop 302 is positioned against the first sidewall 206 and second portion of the countertop 302 is positioned against the back wall 210. Other countertop configurations are considered herein. In some examples, the one or more base cabinets 304 may include a first base cabinet, wherein the back of the first base cabinet is positioned against first the side wall 206 and a second base cabinet, wherein the back of the second base cabinet is positioned against the back wall 210.

In some examples, the first lower supporting member 216 may have a top surface, and a first height may be defined between the top surface of the first lower supporting member 216 and the floor 214. The second lower supporting member 218 may be coupled to the second sidewall 208 and may also have a top surface. A second height may be defined between the top surface of the second lower supporting member 218 and the floor 214. In some examples, the first and second height may be equal. In some examples, as in FIG. 2, when the lower sleeping unit 204 is in the deployed position the lower frame 232 may be positioned on the first and second lower supporting members 216, 218.

As illustrated in the example of FIG. 3, the first lower supporting member 216 may be a work surface such as a desk or a countertop 302 with base cabinets 304. In some examples, the top surface of the first lower supporting member 216 may comprise marble, quartz, granite, butcher block, laminate, wood, or another surface typically used for a desk or a countertop 302. According to some examples, the second lower supporting member 218 may comprise wood, metal, plastic, a synthetic, or another material capable of supporting the lower frame 232, lower mattress 234, and a load applied on the lower frame and mattress 232, 234.

When the lower sleeping unit 204 is in the deployed position, the lower frame 232 may be positioned on the first and second lower supporting members 216, 218. According to some embodiments, when the lower sleeping unit 204 is in the stowed position, the lower frame 232 may be folded and positioned on the portion of the countertop 302 towards the back wall 210, and the countertop 302 may be substantially accessible. In some examples, when the lower supporting member 216 is a desk or kitchen countertop, the desk or kitchen countertop may be substantially accessible when the lower sleeping unit 204 is in the stowed position.

As illustrated in FIGS. 2-3, the first upper supporting member 220 may be coupled to the first sidewall 206 and the second upper supporting member 222 may be coupled to the second sidewall 208. The first upper supporting member 220 may have a third height defined between the first upper supporting member 220 and the floor 214, and the second upper supporting member 222 may have a fourth height defined between the second upper supporting member 222 and the floor 214. According to some examples, the third height may equal the fourth height. The third and fourth heights may be larger than the first and second heights. In other words, the height of the first and second upper supporting members 220, 222 may be greater than the heights of the first and second lower supporting members 216, 218. The first and second upper supporting members 220, 222 may be configured to support the upper sleeping unit 202. More specifically, when the upper sleeping unit is in the deployed position, the upper frame 224 may be positioned on the first and second upper supporting members 220, 222, and the upper mattress 226 may be positioned on the upper frame 224. In some examples, the upper supporting members 220, 222 may be metal brackets. In some embodiments, the upper supporting members 220 may comprise wood, plastic, a synthetic, or any other material or combination of materials capable of supporting the upper mattress 226, upper frame 224, and a load on the upper mattress 226 and upper frame 224.

Referring now to FIG. 4, one example of the upper sleeping unit 202 in a stowed position is illustrated. The upper sleeping unit 202 may include the upper frame 224 which may be coupled to a first bracket 402. The first bracket 402 may be coupled to the first upper supporting member 220 via one or more dampers, and the first upper supporting member 220 may be coupled to the first sidewall 206. In the illustrative example of FIG. 4, the one or more dampers may include a first damper 404 and a second damper 406. Other damper configurations are also considered herein.

The first damper may include a first arm 408 coupled to a first housing 410, and the second damper 406 may include a second arm 412 coupled to a second housing 414. The first housing 410 may have an outer diameter that is greater than the outer diameter of the first arm 408, and the second housing 414 may have an outer diameter that is greater than the second arm 412. The first and second arms 408, 410 may be configured to move at least partially into and at least partially out of the corresponding first and second housings 410, 414.

FIG. 5 illustrates an example of the upper sleeping unit 202 in a stowed position wherein the upper frame 224 is coupled to a second bracket 502. The second bracket 502 may be coupled to the second upper supporting member 222 via one or more dampers. In some examples, the second upper supporting member 222 may be coupled to the second sidewall 208. In some examples, as in FIG. 5, the one or more dampers may include a third damper 504 and a fourth damper 506. Other damper configurations are also considered herein.

The third damper 504 may have a third arm 506 coupled to a third housing 510 and the fourth damper 506 may include a fourth arm 512 coupled to a fourth housing 514. In some examples, the third housing 510 and fourth housing 514 may have larger outer diameters relative to the outer diameters of the corresponding arms 508, 512. The third and fourth arms 508, 512 may be configured to move at least partially into and at least partially out of the corresponding third and fourth housings 510, 514.

In some examples, when the upper frame 224 is in deployed position, the upper frame 224, or the first and second brackets 402, 502 coupled to the upper frame 224, may be positioned on the first and second upper supporting members 220, 222. When the upper sleeping unit 202 moves from the deployed position to the stowed position, the upper sleeping unit 202, along with the first and second brackets 402, 502 coupled to the upper sleeping unit 202 may move towards the ceiling 212. Also, when upper sleeping unit 202 moves towards the stowed position, the first, second, third and fourth arms 408, 412, 508, 512 may move at least partially out of the corresponding first, second, third, and fourth housings 410, 414, 510, 514. In some examples, when the upper sleeping unit 202 is in the stowed position, the upper sleeping unit 202 may be supported by the dampers 404, 406, 504, 506. In some embodiments, the upper sleeping unit 202 may have a locking mechanism, and the locking mechanism may lock the upper sleeping unit 202 in the stowed position.

In some examples, the upper sleeping unit 202 may be in the stowed position and may move to the deployed position. In these examples, the upper sleeping unit 202, along with the first and second brackets 402, 502 coupled to the upper frame 224 may move towards the first and second upper supporting member 220, 222. In some examples, a top surface of the first upper supporting member 220 may have one or more stoppers 416, and the top surface of the second upper supporting member 220 may have one or more stoppers 416. In some examples, when the upper sleeping unit 202 is in the deployed position, the first and second brackets 402, 502 may be in contact with, or positioned on, the one or more stoppers 416. In some examples, the stoppers 416 may comprise a rubber material, plastic material, or another material configured to support and at least partially absorb an impact from the first and second brackets 402, 502. When the upper sleeping unit 202 moves from the stowed position to the deployed position, the first, second, third, and fourth arms 408, 412, 508, 512 may move at least partially into the corresponding first, second, third, and fourth housings 410, 414, 510, 514.

When the first, second, third, and fourth arms 408, 412, 508, 512 move into the corresponding first, second, third, and fourth housings 410, 414, 510, 514, the first, second, third, and fourth dampers 404, 406, 504, 506 may be in a retracted or partially retracted position. When the first, second, third, and fourth arms 408, 412, 508, 512 move out of the corresponding first, second, third, and fourth housings 410, 414, 510, 514, the first, second, third, and fourth dampers 404, 406, 504, 506 may be in an extended or partially extended position. In some examples, the dampers 404, 406, 504, 506 may provide resistance when the dampers 404, 406, 504, 506 move from the extended or partially extended position to the compressed or partially compressed position. According to some examples, the dampers 404, 406, 504, 506 may provide resistance when the dampers 404, 406, 504, 506 move from the compressed or partially compressed position to the extended or partially extended position.

In some examples, as illustrated in FIGS. 4-5, the first and second dampers 404, 406 may be coupled to the first upper supporting member 220 and to the first bracket 402, and the third and fourth dampers 504, 506 may be coupled to the second upper supporting member 222 and the second bracket 502. More specifically, the first and second arms 408, 412 may be coupled to the first upper supporting member 220 and the first and second housings 410, 414 may be coupled to the first bracket 402. The third and fourth arms 508, 512 may be coupled to the second upper supporting member 222 and the third and fourth housings 510, 514 may be coupled to the second bracket 502. In some examples, the arms 408, 412, 508, 512 may be moveably coupled to the upper supporting members 220, 222. According to some examples, the arms 408, 412, 508, 512 may be pivotably coupled to the corresponding first and second upper supporting members 220, 222.

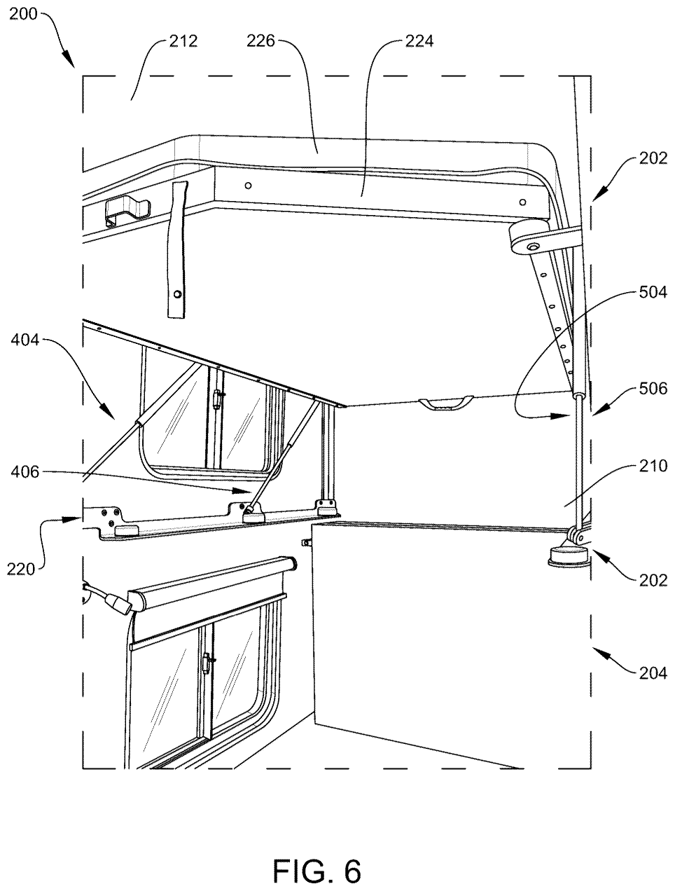

FIG. 6 illustrates one example of the upper sleeping unit 202 in the stowed position and the lower sleeping unit 204 in the stowed position. In some examples, when the upper sleeping unit 202 is in the stowed position, it may be parallel to the ceiling 212 and when the lower sleeping unit 204 is in the stowed position, it may be in a folded position that is substantially perpendicular to the ceiling 212. According to some examples, when the upper sleeping unit 202 is in the stowed position, the dampers 404, 406, 504, 506 may be in the extended or the partially extended position, thereby positioning the upper sleeping unit 202 adjacent to the ceiling 212. As illustrated in FIG. 6, the lower sleeping unit 204 may be folded and positioned towards the backwall 210. In some examples, when the lower sleeping unit 204 is in the stowed position, it may be supported by one or more of the first or second lower supporting members 216, 218. The upper sleeping unit 202 may move between the deployed and stowed positions independent of the lower sleeping unit 204. In some examples, the lower sleeping unit 204 may move between the deployed and stowed positions independent of the upper sleeping unit 202. Accordingly, the present disclosure provides for reconfigurable compartments that can be configured to maximize sleeping space while also allowing for configurations that maximize workspace when one or more of the sleeping units are not needed or in use. The disclosed sleeping units and compartments are therefore suitable for smaller applications, such as travel trailer bunkhouses, as well as larger applications.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A vehicle, comprising:
an interior defined by a floor, ceiling, and a plurality of walls;
a first and second sleeping unit positioned in the interior, the first and second sleeping units each configured to move between a deployed position and a stowed position;
a first lower supporting member coupled to one or more of the plurality of walls, the first lower supporting member configured to support the second sleeping unit in the deployed position;
wherein, when the first sleeping unit moves from the deployed position to the stowed position, the first sleeping unit moves towards the ceiling;
wherein, when the second sleeping unit moves from the deployed position to the stowed position, the second sleeping unit is folded against one of the plurality of walls.

2. The vehicle of claim 1, further comprising a second lower supporting member coupled to one of the plurality of walls opposite the first lower supporting member.

3. The vehicle of claim 2, wherein one of the first or second lower supporting members comprises a work surface.

4. The vehicle of claim 1, further comprising first and second upper supporting members configured to support the first sleeping unit, wherein the upper supporting members include one or more dampers configured to move between an extended position and a compressed position.

5. The vehicle of claim 1, further comprising a lock, wherein at least one of the first and second sleeping units are configured to lock in the stowed position via the lock.

6. The vehicle of claim 1, wherein the first sleeping unit is positioned over the second sleeping unit such that the first sleeping unit and the second sleeping unit occupy the same floor space when the first and second sleeping units are deployed.

7. The vehicle of claim 1, wherein the first sleeping unit is positioned above the second sleeping unit.

8. The vehicle of claim 1, wherein the first unit moves between the deployed and stowed positions independently relative to the second sleeping unit, and the second sleeping unit moves between the deployed and stowed positions independently relative to the first sleeping unit.

9. The vehicle of claim 1, wherein the first and second sleeping units each comprise a platform and a mattress.

10. A reconfigurable compartment, comprising:
two opposed walls and a ceiling;
a work surface positioned between the two opposed walls;
an upper sleeping unit configured to move between a deployed position and an elevated stowed position; and
a lower sleeping unit configured to move between a deployed position supported by the work surface and a stowed position.

11. The compartment of claim 10, wherein the upper sleeping unit is positioned against the ceiling in the stowed position.

12. The compartment of claim 10, wherein the lower sleeping unit is folded in the stowed position.

13. The compartment of claim 10, further comprising a supporting member coupled to one of the two opposed walls opposite the work surface and at the same height as the work surface.

14. The compartment of claim 10, further comprising first and second upper supporting members configured to support the upper sleeping unit, wherein the upper supporting members include one or more dampers configured to move between an extended position and a compressed position when the upper sleeping unit is moved from the stowed position to the deployed position.

15. The compartment of claim 10, further comprising a lock, wherein at least one of the upper and lower sleeping units are configured to lock in the stowed position via the lock.

16. The compartment of claim 10, wherein the upper sleeping unit is positioned over the lower sleeping unit such that the upper sleeping unit and the lower sleeping unit occupy the same floor space when the upper and lower sleeping units are deployed.

17. The compartment of claim 10, wherein the upper sleeping unit moves between the deployed and stowed positions independently relative to the lower sleeping unit, and the lower sleeping unit moves between the deployed and stowed positions independently relative to the upper sleeping unit.

18. The compartment of claim 10, wherein the upper and lower sleeping units each comprise a platform and a mattress.

19. The compartment of claim 10, wherein the work surface has an L-configuration, whereby a first portion of the work surface is positioned against one of the two opposed walls and a second portion of the work surface is positioned against a back wall extending between the two opposed walls.

20. The compartment of claim 19, wherein the lower sleeping unit is folded against the back wall in the stowed position.
